(19) United States
(12) Patent Application Publication
(10) Pub. No.: US 2012/0244512 A1
(43) Pub. Date: Sep. 27, 2012

(54) Driving Force, Versatile Door Prop For Forcible Entry Training

(76) Inventor: Jonathan Paul Norris, Pensacola, FL (US)

(21) Appl. No.: 13/422,983

(22) Filed: Mar. 16, 2012

Related U.S. Application Data
(60) Provisional application No. 61/465,477, filed on Mar. 21, 2011.

(51) Int. Cl. G09B 25/00

(52) U.S. Cl. 434/387

(57) ABSTRACT

This invention is a steel door prop to simulate a typical hollow metal frame, a plywood door with either a reusable metal edge or a disposable metal edge and a reusable lock. The door prop can also be used with a conventional door. The invention is designed to be used by fire departments, military, and law enforcement agencies to train personnel in the art of opening locked or blocked doors. The special benefits to the invention are versatility, portability, and cost savings.

### RELATED APPLICATIONS

The present application claims the benefit of U.S. Provisional Application No. 61/465,477, filed: Mar. 21, 2011.

### BACKGROUND OF THE INVENTION

The invention is designed to demonstrate the quickest way to open a locked door. One of the versatile elements of this invention is the capability of training on residential and commercial wood and hollow metal doors. Training evolutions are generally performed on real doors. While this is the most realistic way to train, it is also the most expensive and logistically challenging. The purpose of this invention is to maintain realistic training with a combination of reusable and consumable components. This invention fills these needs.

### SUMMARY OF THE INVENTION

It is the purpose of the invention to act as a training tool for opening residential as well as commercial doors with a variety of techniques and breaching tools.

The invention includes a unique steel door frame to simulate a hollow metal door frame in a real building. Another unique aspect is the option of the trainer to use either a new or scrap hollow metal door obtained from a hollow metal door company, a wood door, a metal clad residential door, or the reusable plywood door with a replaceable metal edge, which is a part of this invention.

The plywood door that is part of this invention simulates a real door. The plywood door is the same thickness as a real door and has a metal edge that perfectly simulates a hollow metal door edge. Rather than replacing a complete door for every evolution, only the much less expensive metal door edge has to be replaced. The metal door edge is constructed of steel of the same gage as a commercial hollow metal door and takes the exact same force to crush as a commercial hollow metal door. The doors can be mounted as doors that open out, doors that open in, left hand, and right hand. Adding to the unique versatility of the invention is the fact that the door prop can be used as a free standing unit, can be installed in a room with a ceiling eight feet tall, or can be installed in a steel storage container.

Adding to its versatility is the fact that the prop is bolted together rather than welded to make it portable for transit or shipping. This unique design allows the prop to be disassembled and moved to eliminate the necessity of buying one for each training location or the necessity of transporting personnel to a designated training site.

### BRIEF DESCRIPTION OF THE DRAWINGS

FIG. 1 illustrates the view of the door and frame from the front side with the floor grate.

FIG. 2 illustrates the view of the door and frame from the left or hinge side.

FIG. 3 illustrates the view of the door and frame from the rear or side without the grate.

FIG. 4 illustrates the view of the door and frame from the right or latch side.

FIG. 5 illustrates the disposable door edge which is installed on the plywood door.

FIG. 6 illustrates the reusable door lock

### DETAILED DESCRIPTION OF THE DRAWINGS

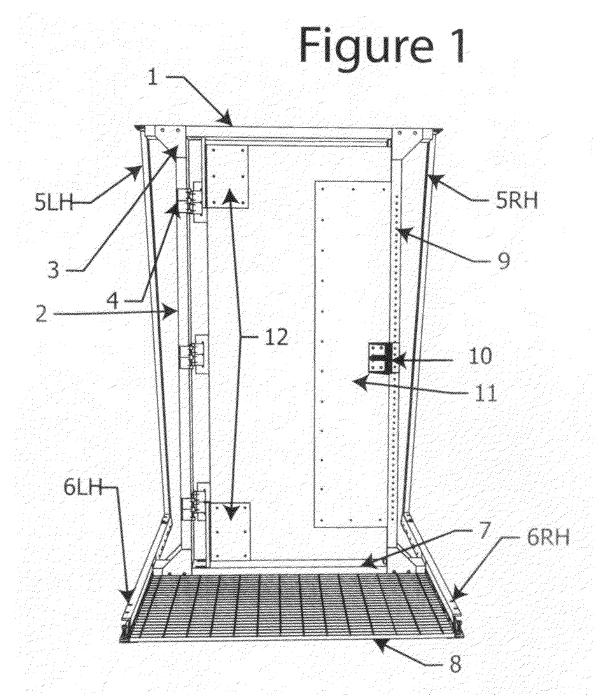

FIG. 1 shows 1 the top plate, 2 the hinge jamb, 9 the locking jamb, 7 the bottom plate, and 3 the four angle brackets holding the four parts together, making a complete door frame in which to install a door. FIG. 1 also shows 4 the 4.5 inch door hinges for mounting doors in frame, 5 the left hand and right hand braces for stabilizing the frame, 6 the left hand and right hand legs, 8 the floor grate, 10 the prop lock (one of the most unique parts of the invention having a replaceable shear pin to simulate the breaking of a lock), 11 the replaceable metal door edge (another unique part of the invention), and 12 the sliding hinge pins for hanging the door in the frame.

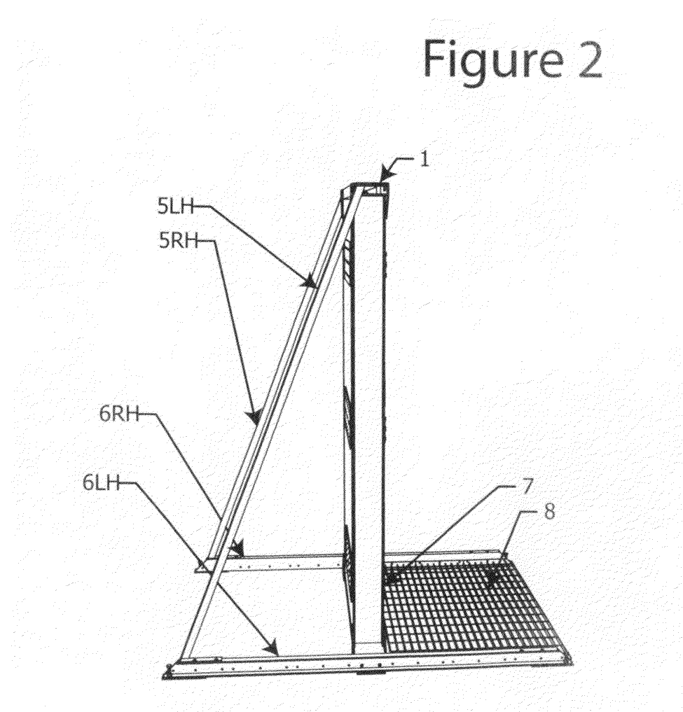

FIG. 2 shows the side view of the components previously described in FIG. 1.

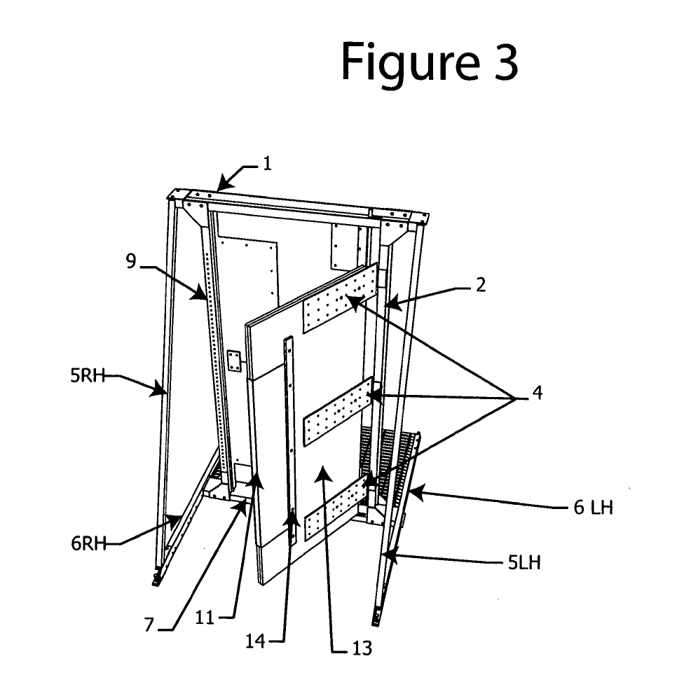

FIG. 3 shows, in addition to parts already covered in FIGS. 1 and 2, 13 the plywood door and 14 the mounting bracket holding the replaceable metal door edge on the plywood door.

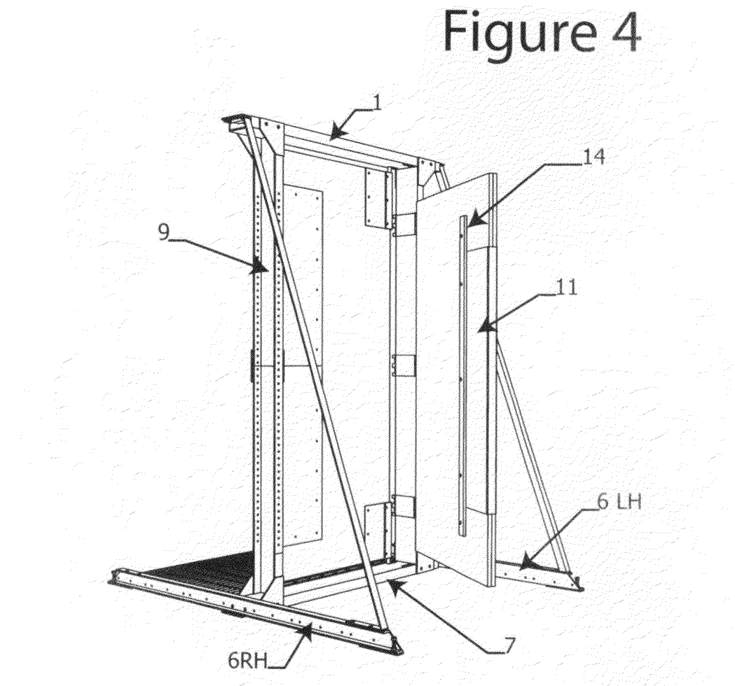

FIG. 4 shows parts already covered in previous figures from an additional angle.

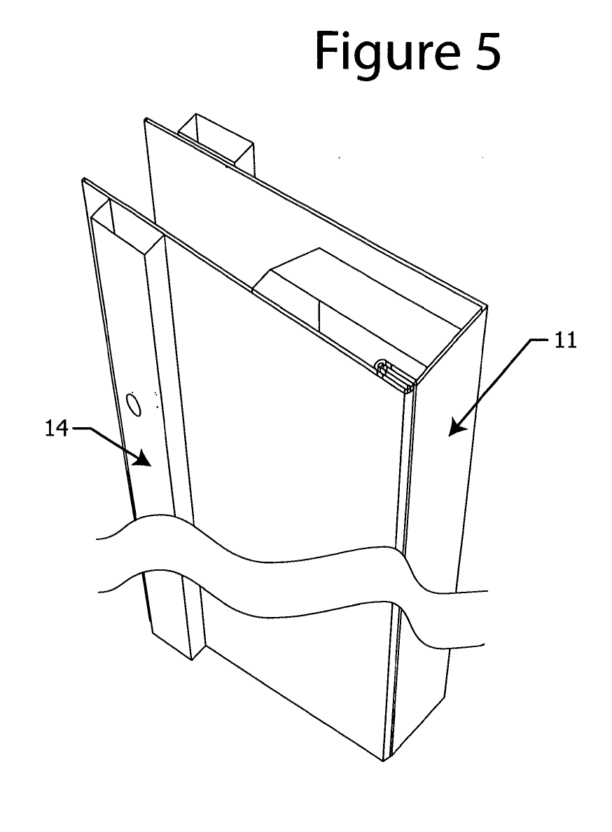

FIG. 5 shows 11 the door edge with a locking seam and foam core and 14 the door edge clamp.

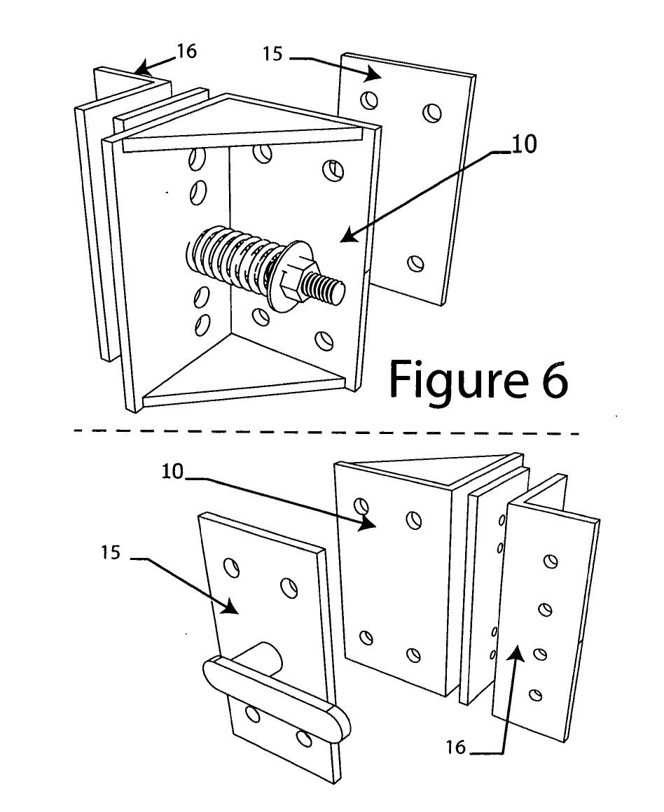

FIG. 6 shows 10 the main component of the spring loaded shear lock with the nut, bolt, and tensioner spring, 15 the dummy lever, and 16 the jamb strike plate for the shear bolts.

What is claimed is:

1. A steel door prop that is a realistic simulation of a hollow metal door frame in a real building comprising:
a locking jamb;
a hinge jamb with welded hinges;
a top plate and bottom plate;
two angle braces; and
two floor grates.

2. The door prop as recited in claim 1, wherein:
the door prop can be used with a conventional door;
the door prop can be used with a plywood door with a reusable metal edge; or
the door prop can be used with a plywood door with a disposable metal edge.

3. The door prop as recited in claim 1, wherein:
the door prop can be used as a freestanding unit;
the door prop can be installed in a building with an eight foot ceiling; and
the door prop can be installed in a steel storage container.

4. The door prop as recited in claim 1, wherein:
the door prop is portable in that it is bolted together so as to be disassembled and moved to another location.

5. The door prop as recited in claim 1, wherein:
the invention includes a reusable lock to save the expense of breaking and replacing a new lock on every evolution of a training session; and
the lock includes bolts which act as shear pins which shear at the same force as that required to break a conventional lock.
